(19) United States
(12) Patent Application Publication
(10) Pub. No.: US 2019/0056878 A1
(43) Pub. Date: Feb. 21, 2019

(54) STORAGE CONTROL APPARATUS AND COMPUTER-READABLE RECORDING MEDIUM STORING PROGRAM THEREFOR

(71) Applicant: FUJITSU LIMITED, Kawasaki-shi (JP)

(72) Inventors: Shinichi NISHIZONO, Kawasaki (JP); Yoshihito Konta, Kawasaki (JP)

(73) Assignee: FUJITSU LIMITED, Kawasaki-shi (JP)

(21) Appl. No.: 16/043,445

(22) Filed: Jul. 24, 2018

(30) Foreign Application Priority Data
Aug. 16, 2017 (JP) 2017-156994

(51) Int. Cl. G06F 3/06

(52) U.S. Cl. CPC G06F 3/0632; G06F 3/0673; G06F 3/0653; G06F 3/0604

(57) ABSTRACT

A storage control apparatus is provided, which includes a memory and a control unit. The memory stores information about reference counts each indicating the number of logical addresses that reference a data block and information indicating an update status of each reference count. When a reference count is changed, the control unit updates the information about the reference count in the memory, sets the update status such as to indicate that the reference count has been updated, and at prescribed timing, stores the information about the reference count that has been updated in a storage device and sets the update status such as to indicate that the reference count has not been updated. When performing a process based on the reference counts, the control unit excludes data blocks corresponding to the reference counts that have been updated, from the process.

### CROSS-REFERENCE TO RELATED APPLICATION

This application is based upon and claims the benefit of priority of the prior Japanese Patent Application No. 2017-156994, filed on Aug. 16, 2017, the entire contents of which are incorporated herein by reference.

### FIELD

Embodiments discussed herein relate to a storage control apparatus and a computer-readable recording medium storing a program therefor.

### BACKGROUND

In storage systems, a technique called deduplication may be used to reduce the amount of data stored in a storage device, such as a hard disk drive (HDD) or solid state drive (SSD). The deduplication is to determine whether data (write data) to be written to a storage device is a duplicate of data (existing data) already stored in the storage device and avoid writing duplicate write data. By performing the deduplication, the logical address (LA) of the write data is mapped to the physical address of the existing data.

The deduplication is performed in units of data blocks. Data blocks have a prescribed size. For example, in the case where a data block (write block) to be written to a storage device is a duplicate of a data block (existing block) already stored in the storage device, the logical address of the write block is mapped to the physical address of the existing block. In this connection, if a plurality of write blocks are duplicates of a single existing block, a plurality of logical addresses are mapped to the same physical address, so that the same physical address is referenced by the plurality of logical addresses.

The number of logical addresses that reference an individual existing block (i.e., reference count) is managed using a reference counter, which is metadata. The size of the reference counters increases with an increase in the number of data blocks stored in a storage device. Therefore, if a memory does not have a space enough to store all the reference counters, the reference counters are stored in the storage device.

The reference counters are used in a process of creating a free space by removing data blocks that are no more in use in the storage device (this process is called garbage collection (GC)). The GC is to remove data blocks stored at physical addresses with reference counts of zero. Here, it is assumed that the deduplication and GC are performed in units of data blocks for easy understanding, but these may be performed in units of anything other than data blocks.

For the deduplication, the following mechanism has been proposed: a file is divided into block files, and if a block file is a duplicate of any of block files already registered or stored, the block file is not uploaded but an updated part of metadata or deduplication management database is uploaded. The following mechanism also has been proposed: the locations of divided data in a file are registered, address information of the divided data corresponding to the locations is stored, and the locations and the address information are managed separately in metadata.

See, for example, Japanese Laid-open Patent Publication Nos. 2012-141738 and 2010-204970.

Reference counters are rewritten according to access to data blocks. Therefore, in the case where a storage device that has a limited number of rewrites, such as an SSD, is used, frequent rewrites of the reference counters may shorten the lifetime of the storage device. This risk may be reduced by storing metadata that is frequently rewritten, in a memory of a storage control apparatus. However, another risk arises where the reference counters consume memory capacity.

It would reduce the above risk regarding the lifetime of the storage device if some of the reference counters are cached in the memory, the reference counters in the memory are updated, and then the updated reference counters are written to the storage device at prescribed timing. In addition, it would avoid the above risk regarding the consumption of memory capacity if only a limited amount of data on the reference counters is stored in the memory.

However, if data blocks are modified or removed on the basis of the reference counters stored in the storage device under the situation where updates of the reference counters stored in the memory are not yet reflected on the reference counters stored in the storage device (that is, in an asynchronous state), some data blocks may be lost.

For example, in the case where an update is not reflected on the reference counters stored in the storage device due to a failure of the storage control apparatus and the GC is performed on the basis of the reference counters stored in the storage device, the following risk arises: a data block that needs to be excluded from the GC may be removed in the GC. This risk arises depending on the load status or the setting of timing for synchronization, other than the failure of the storage control apparatus.

### SUMMARY

According to one aspect, there is provided a storage control apparatus including: a memory configured to store information about a reference count indicating a number of logical addresses that reference a data block and information indicating an update status of the reference count; and a processor configured to perform a first process including updating, when the reference count is changed, the information about the reference count stored in the memory and setting the update status such as to indicate that the reference count has been updated, storing, at prescribed timing, the information about the reference count that has been updated in a storage device and setting the update status such as to indicate that the reference count has not been updated, and excluding, when performing a second process based on the reference count, the data block corresponding to the reference count that has been updated, from the second process.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a storage system according to a first embodiment;

FIG. 2 illustrates an example of a storage system according to a second embodiment;

FIG. 3 is a view for explaining how to control writing of user data;

FIG. 4 is a view for explaining how to perform deduplication on user data and management of a hash cache;

FIG. 5 is a view for explaining the structure of a hash cache;

FIG. 6 is a view for explaining a memory (control information area) of a controller module and control information stored in a storage device;

FIG. 7 is a view for explaining the relationship between block map, container meta-information, and reference counter;

FIG. 8 is a view for explaining how to update journal information, update flag information, and reference counter along with an update of the block map;

FIG. 9 is a flow diagram for explaining how to write user data;

FIG. 10 is a flow diagram for explaining how to update control information;

FIG. 11 is a flow diagram for explaining how to update a reference counter;

FIG. 12 is a flow diagram for explaining how to perform a garbage collection process; and

FIG. 13 is a flow diagram for explaining how to read user data.

### DESCRIPTION OF EMBODIMENTS

Hereinafter, preferred embodiments will be described in detail with reference to the accompanying drawings. Note that elements having substantially the same features are given the same reference numeral in the description and drawings, and description thereof will not be repeated.

### 1. First Embodiment

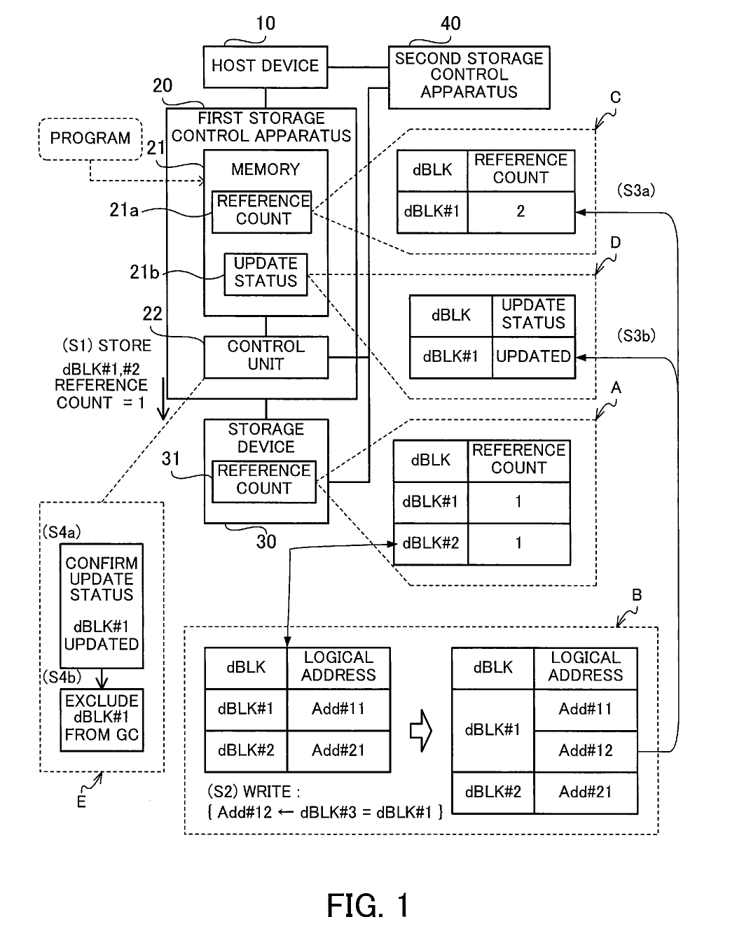

A first embodiment will be described with reference to FIG. 1. The first embodiment relates to a storage system in which deduplication is performed in units of data blocks when user data is written. FIG. 1 illustrates an example of a storage system according to the first embodiment.

As illustrated in FIG. 1, the storage system of the first embodiment includes a host device 10, a first storage control apparatus 20, a storage device 30, and a second storage control apparatus 40.

Note that a unit including the first storage control apparatus 20, the storage device 30, and the second storage control apparatus 40 is an example of a storage apparatus. A controller module (CM) that is provided in a storage apparatus is an example of the first and second storage control apparatuses 20 and 40. The first and second storage control apparatuses 20 and 40 may be provided in the same storage apparatus or in different storage apparatuses. For example, the technique described in the first embodiment is applicable to a scale-out storage system in which a plurality of CMs provided in different storage apparatuses operate in cooperation with each other.

The host device 10 is a computer that accesses the storage device 30 via one or both of the first and second storage control apparatuses 20 and 40. Personal computers (PC) and server devices are examples of the host device 10. For example, the host device 10 issues write requests and read requests for user data to the first storage control apparatus 20.

The first storage control apparatus 20 includes a memory 21 and a control unit 22.

The memory 21 is a volatile memory device, such as a random access memory (RAM), or a non-volatile memory device, such as an HDD, SSD, or flash memory, for example. The control unit 22 is a processor, such as a central processing unit (CPU), a digital signal processor (DSP), an application specific integrated circuit (ASIC), or field programmable gate array (FPGA). The control unit 22 runs programs stored in the memory 21, for example.

When the first storage control apparatus 20 receives a write request for user data from the host device 10, the control unit 22 divides the user data into data blocks of prescribed size and calculates a hash value of each data block (target data block). Then, the control unit 22 compares each calculated hash value with the hash values of data blocks (existing data blocks) already stored in a physical storage space provided by one or both of the memory 21 and storage device 30.

If the hash value of any of the existing data blocks is found to be the same as a calculated hash value, the control unit 22 maps the logical address to which to write the corresponding target data block, to the found existing data block and returns a write completion notification to the host device 10. Since a hash value depends on the contents of a data block, the above technique makes it possible to avoid redundantly writing a data block having the same contents as a data block existing in the physical storage space. That is to say, the data block is deduplicated.

After the deduplication is performed, the same data block is referenced by a plurality of logical addresses. To manage the references to the data block by the logical addresses, the memory 21 stores therein information about reference counts 21a each indicating the number of logical addresses that reference a data block and information indicating an update status 21b of each reference count 21a.

When a reference count 21a is changed, the control unit 22 updates the information about the reference count 21a in the memory 21 and also sets the corresponding update status 21b to UPDATED (meaning that the reference count 21a has been updated). Then, the control unit 22 stores the information about the reference count 21a that has been updated in the storage device 30 at prescribed timing and sets the update status 21b to NOT-UPDATED (meaning that the reference count 21a has not been updated). For simple explanation, the reference counts 21a included in the information stored in the storage device 30 are referred to as reference counts 31.

While the first storage control apparatus 20 operates properly, the information about the reference counts 21a is stored in the storage device 30 at prescribed timing. By doing so, the reference counts 31 becomes identical to the reference counts 21a. However, if the reference counts 31 are not synchronized with the reference counts 21a due to a failure of the first storage control apparatus 20 or another problem, a process based on the reference counts 31 has a risk of losing data blocks. In this connection, garbage collection (GC) is an example of processes based on the reference counts 31.

To deal with this, when performing a process based on the reference counts 31, the control unit 22 excludes data blocks corresponding to reference counts 21a that have been updated, from the process. In a situation where the reference counts 31 are in synchronization with the reference counts 21a, the update statuses 21b indicate that the reference counts 21a have not been updated. In a situation where the reference counts 31 are not in synchronization with the reference counts 21a, on the other hand, the update statuses 21b indicate that the reference counts 21a have been updated. The use of the update statuses 21b enables specifying which data blocks are to be subjected to the process based on the reference counts 31, so as to thereby avoid the risk of losing data blocks.

For example, assuming that data blocks dBLK#1 and dBLK#2 that are not duplicates are stored in logical addresses Add#11 and Add#21, respectively, while there are no existing data blocks (S1), the reference counts 21a of the data blocks dBLK#1 and dBLK#2 are both one. After that, by synchronizing the reference counts 31 with the reference counts 21a, the information about the reference counts 31 is updated as illustrated in a part A of FIG. 1, and the update statuses 21b of the reference counts 21a of the data blocks dBLK#1 and dBLK#2 are set to NOT-UPDATED.

Under this situation, when a data block dBLK#3 having the same contents as the data block dBLK#1 is stored in a logical address Add#12, as illustrated in a part B of FIG. 1 (S2), deduplication is performed, so that the logical address Add#12 is mapped to the data block dBLK#1.

The control unit 22 updates the information about the reference counts 21a to change the reference count of the data block dBLK#1 to two, as illustrated in a part C of FIG. 1 (S3a). In addition, the control unit 22 sets the update status 21b of the data block dBLK#1 to UPDATED (S3b), as illustrated in a part D of FIG. 1. In the case where the GC is performed under this situation, the update statuses 21b are confirmed (S4a) and the data block dBLK#1 is excluded from the GC (S4b), as illustrated in a part E of FIG. 1. That is to say, the data block dBLK#1 is prevented from being subjected to the GC.

In this connection, the data block dBLK#1 is referenced by the logical addresses after the above S3b is completed, and therefore the data block dBLK#1 needs to be excluded from the GC. However, if the second storage control apparatus 40 performs the GC under a situation where the reference counts 31 are different from the reference counts 21a (for example, if a reference count 21a has a value of one and its corresponding reference count 31 has a value of zero), the risk of losing data blocks may arise.

By being notified of the update statuses 21b, the second storage control apparatus 40 is able to exclude the data block dBLK#1 from the GC according to the above S4a and S4b. Even in the case where the reference counts 31 are not yet synchronized with the reference counts 21a due to a failure of the first storage control apparatus 20 or another problem, the second storage control apparatus 40 is able to avoid the risk of losing data blocks in the GC.

Heretofore, the first embodiment has been described.

A situation where the reference counts 31 are not in synchronization with the reference counts 21a may maintain due to some reasons other than failure. In addition, the reference counts 31 may be used in processes that are performed on data blocks, other than the GC. By applying the technique described above in the first embodiment to such situations in the same way, it is possible to avoid the risk of losing data blocks.

### 2. Second Embodiment

A second embodiment will now be described. The second embodiment relates to a storage system in which deduplication is performed in units of data blocks when user data is written.

(2-1. Storage System)

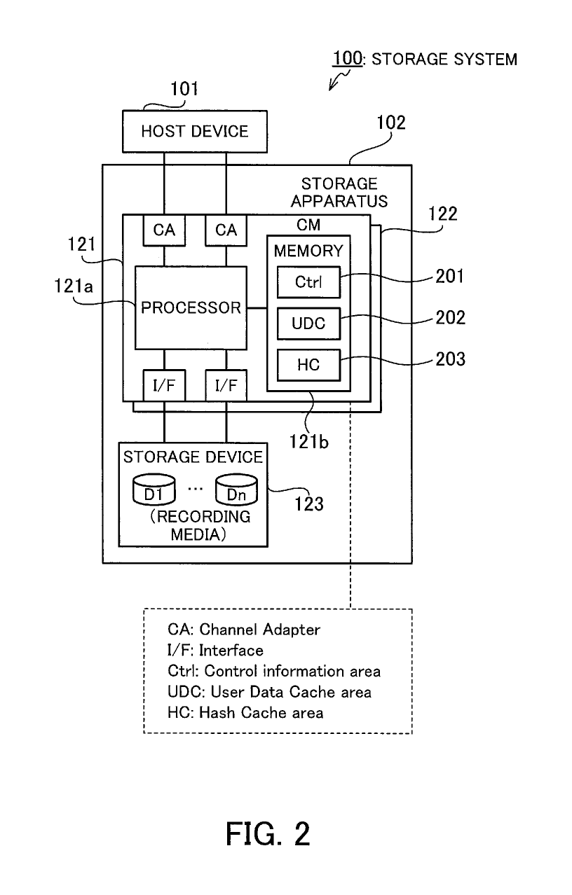

A storage system 100 will now be described with reference to FIG. 2. FIG. 2 illustrates an example of a storage system according to the second embodiment. The storage system 100 in FIG. 2 is an example of the storage system of the second embodiment.

As illustrated in FIG. 2, the storage system 100 includes a host device 101 and a storage apparatus 102. The storage apparatus 102 includes CMs 121 and 122 and a storage device 123.

FIG. 2 illustrates an example where two CMs are provided in the storage apparatus 102. However, the technique described in the second embodiment is applicable to the case where any other number of CMs are provided in the storage apparatus 102. In addition, assuming that the CMs 121 and 122 have substantially the same hardware configuration and functions, the detailed description of the CM 122 will be omitted.

The CM 121 includes a plurality of channel adapters (CAs), a plurality of interfaces (I/Fs), a processor 121a, and a memory 121b.

The CAs are adapter circuits that control connection with the host device 101. For example, a CA is connected to a host bus adapter (HBA) provided in the host device 101 or a switch provided between the CA and the host device 101, via a Fibre Channel or another communications link. The interfaces are to connect with the storage device 123 via a Serial Attached SCSI (SAS), a Serial ATA (SATA), or another link.

The processor 121a may be a CPU, DSP, ASIC, FPGA, or another, for example. The memory 121b is a RAM, a flash memory, or another, for example. In this connection, FIG. 2 illustrates an example where the memory 121b is provided in the CM 121, but a memory provided outside the CM 121 may be used.

The memory 121b has a control information area (Ctrl) 201 for storing control information (to be described later) and a user data cache area (UDC) 202 for temporarily storing user data. In addition, the memory 121b has a hash cache area (HC) 203 for storing the hash values of data when the data is written.

The UDC 202 is an example of a physical storage space. In addition, at least part of the UDC 202 and HC 203 may be provided in a memory provided outside the CM 121. In addition, the UDC 202 and HC 203 may be provided in different memories.

The storage device 123 includes recording media D1, . . . , and Dn. The recording media D1, . . . , and Dn may be SSDs, HDDs, or others, for example. The recording media D1, . . . , and Dn may include plural types of recording media (HDD, SDD and others). Any desired number of recording media may be provided in the storage device 123. A disk array (storage array), RAID device, and the like are examples of the storage device 123. A storage space, such as a physical volume or a storage pool, which is provided by the storage device 123 is an example of a physical storage space.

The CM 122 has the same elements as the above-described CM 121. In addition, the CMs 121 and 122 are connected to be communicable within the storage apparatus 102. In addition, the CM 122 is able to access the storage device 123, as with the CM 121.

(Write Control)

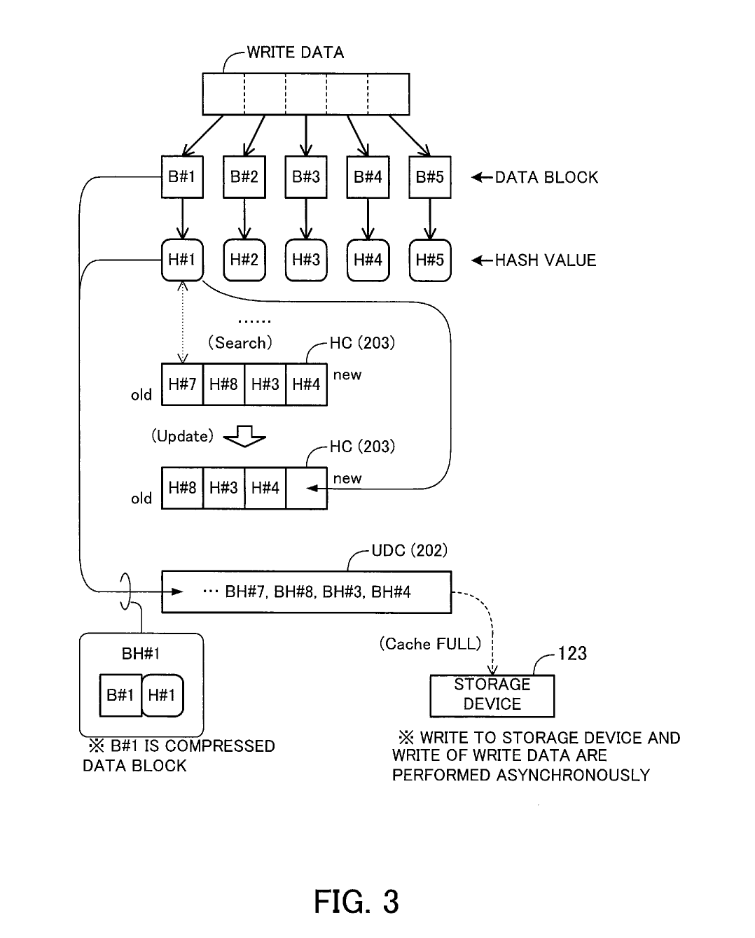

Control for writing user data will be described with reference to FIG. 3. FIG. 3 is a view for explaining how to control writing of user data. In the following description, user data to be written is referred to as write data.

When receiving a write request for write data from the host device 101, the processor 121a divides the write data into data blocks of prescribed size (for example, 4 KB). This size is for performing deduplication. Referring to the example of FIG. 3, the write data is divided into five data blocks B#1, . . . , and B#5. The processor 121a calculates the hash values H#1, . . . , and H#5 of the data blocks B#1, . . . , and B#5, and compares each of the hash values H#1, . . . , and H#5 with hash values stored in the HC 203.

In the example of FIG. 3, the hash values are stored in the order of H#7, H#8, H#3, and H#4, from least recently used (hereinafter, referred to as “oldest”) to most recently used (hereinafter, referred to as “newest”), in the HC 203. For example, the processor 121a compares the hash value H#1 with each of the hash values H#7, H#8, H#3, and H#4 (Search). In this example, the hash value H#1 is not stored in the HC 203. In this case, the processor 121a does not deduplicate the data block B#1 but stores the hash value H#1 in the HC 203.

Note that FIG. 3 illustrates the example where the hash values H#7, H#8, H#3, and H#4 are stored in the HC 203 and there is no free space for storing the hash value H#1. In this case, the processor 121a removes the oldest hash value H#7 from the HC 203 to create a free space in the HC 203. Then, the processor 121a stores the hash value H#1 in the free space of the HC 203. In this way, if the HC 203 is full, a hash value is removed in order from the oldest, and the contents of the HC 203 are updated (Update).

In addition, the processor 121a compresses the data block B#1, which is not deduplicated, and appends the hash value H#1 to the compressed data block B#1 to thereby generate compressed data BH#1. Then, the processor 121a stores the compressed data BH#1 in the UDC 202. If the UDC 202 possibly overflows (for example, if the free space is less than or equal to a prescribed value, if the utilization is greater than or equal to a threshold, or another case), the processor 121a moves compressed data stored in the UDC 202 to the storage device 123, independently of the writing of the write data.

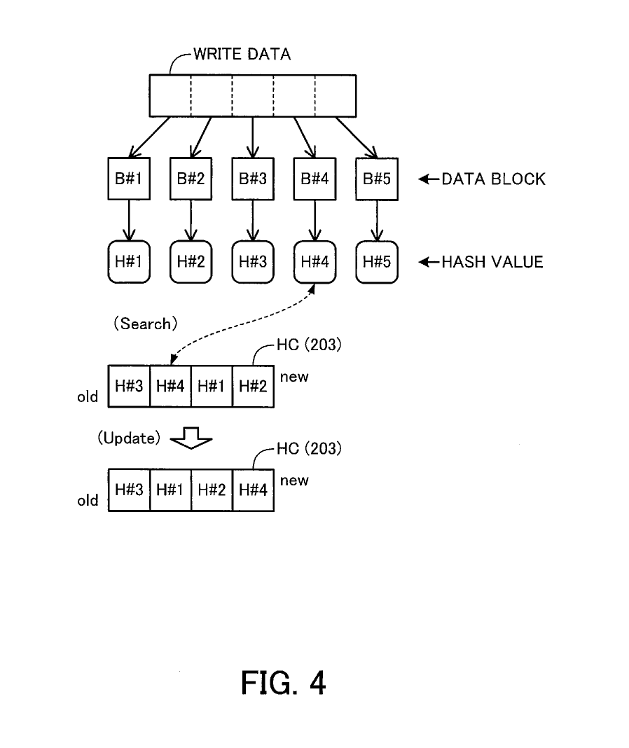

In the case where a data block to be written is not deduplicated, the processor 121a performs the above-described process. However, in the case where the same hash value as the data block is found in the HC 203 as a result of the above search, the processor 121a operates in the way described in FIG. 4. FIG. 4 is a view for explaining how to perform the deduplication on user data and management of a hash cache.

FIG. 4 illustrates an example where hash values are stored in the order of H#3, H#4, H#1, and H#2, from the oldest, in the HC 203. For example, the processor 121a compares a calculated hash value H#4 with each of the hash values H#3, H#4, H#1, and H#2 stored in the HC 203 (Search). In this example, the hash value H#4 is stored in the HC 203. In this case, the processor 121a deduplicates the data block B#4 and moves the hash value H#4 to a location for the newest in the HC 203.

As described above, in the case where the data block B#4 is deduplicated, the processor 121a does not write the data block B#4 or hash value H#4 to the UDC 202 (deduplication). Instead, the processor 121a maps the location to which to write the data block B#4, to the location (i.e., the address of the compressed data BH#4) of the data block B#4 already stored in the UDC 202 or storage device 123, using control information (to be described later), and returns a write completion notification to the host device 101.

(Structure of HC)

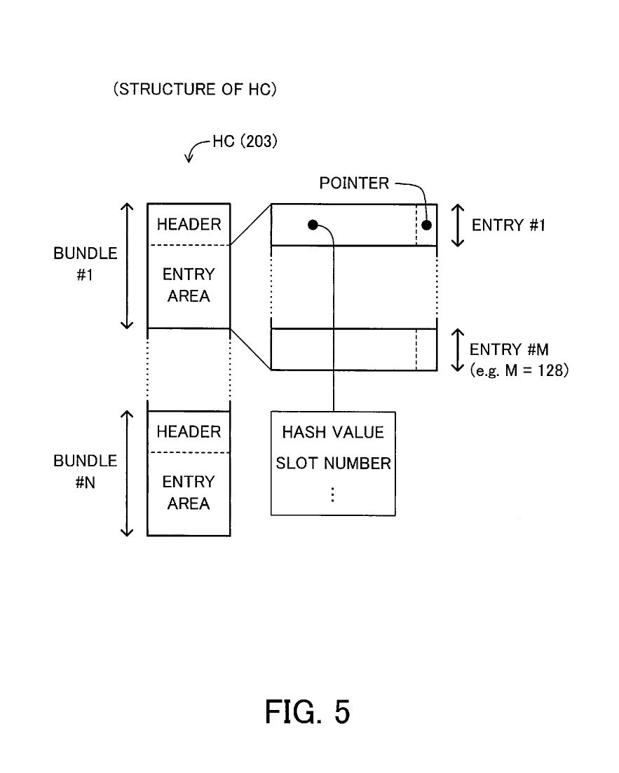

An example of a structure of the HC 203 will now be described with reference to FIG. 5. FIG. 5 is a view for explaining the structure of a hash cache.

As illustrated in FIG. 5, a hash value corresponding to one data block is managed as an entry in the HC 203. In addition, M (for example, M=128) entries may be grouped and managed as a bundle. A bundle includes a header including the identification information of the bundle and an entry area for registering M entries. An entry includes a hash value, a slot number (to be described later), and a pointer pointing to the location of the entry.

The processor 121a manages the old and new statuses of entries in each bundle, and if the entry area overflows, removes the oldest entry and stores a new entry. For example, a bundle that serves as a storage location for a hash value is determined based on a value calculated by dividing the hash value by the total number of bundles. This method makes it possible to determine the storage location from the hash value and the known total number of bundles at the time of search.

(Update of Control Information)

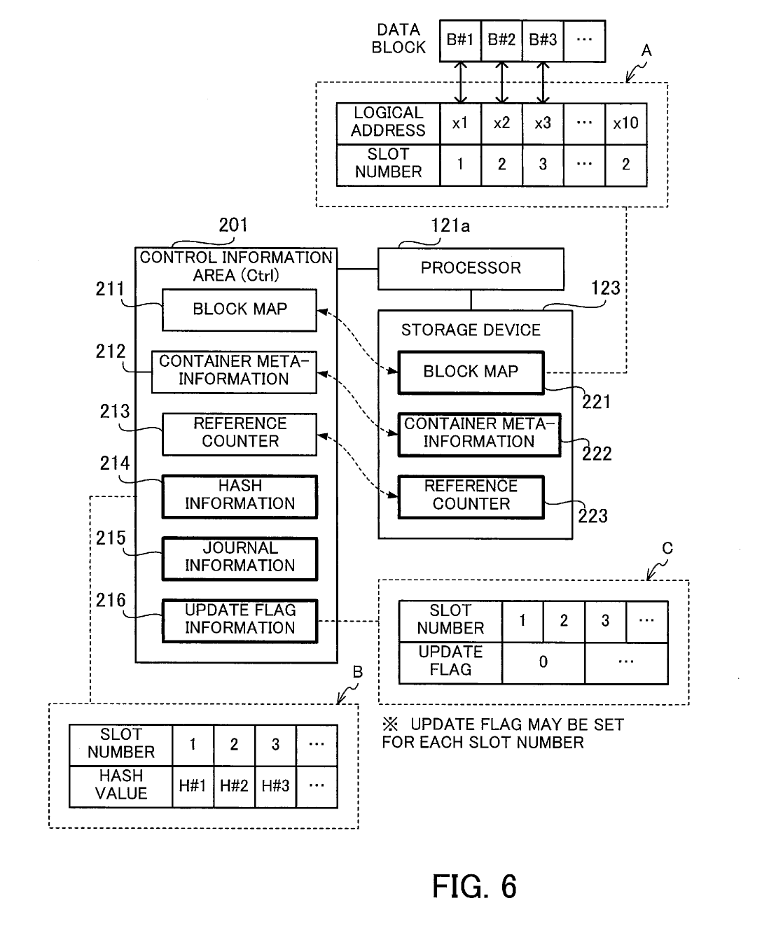

Now, information (control information) stored in the control information area 201 and update of the control information will be described with reference to FIGS. 6 to 8.

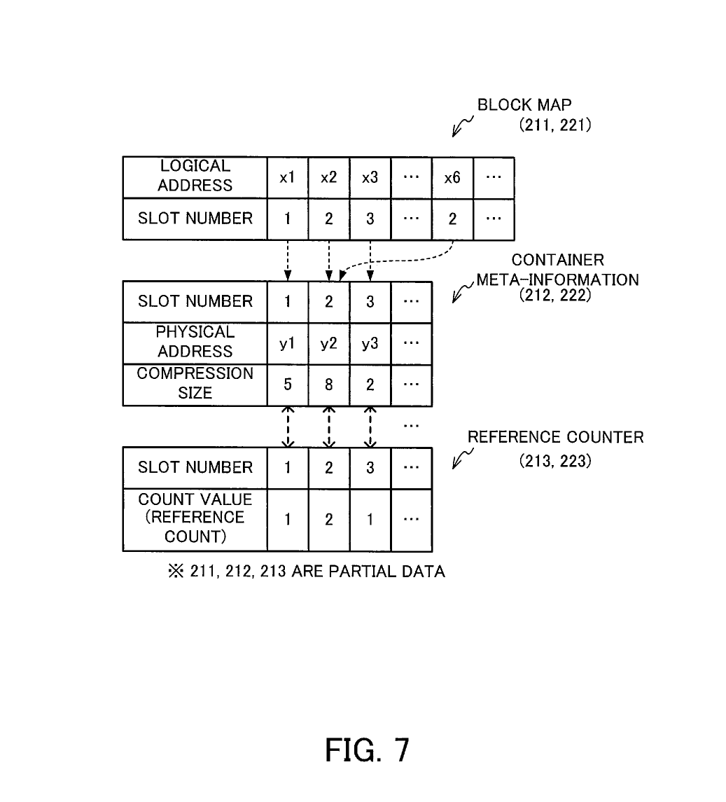

FIG. 6 is a view for explaining a memory (control information area) of a CM and control information stored in the storage device. FIG. 7 is a view for explaining the relationship between block map, container meta-information, and reference counter. FIG. is a view for explaining how to update journal information, update flag information, and reference counter along with an update of the block map.

As illustrated in FIG. 6, the control information area 201 stores therein a block map 211, container meta-information 212, a reference counter 213, hash information 214, journal information 215, and update flag information 216.

In this connection, the block map 211 is part of a block map 221 stored in the storage device 123. The container meta-information 212 is part of container meta-information 222 stored in the storage device 123. The reference counter 213 is part of a reference counter 223 stored in the storage device 123. That is to say, the block map 211, container meta-information 212, and reference counter 213 are cache data of the block map 221, container meta-information 222, and reference counter 223, respectively.

As described earlier, user data is divided into data blocks of prescribed size and managed in units of data blocks in the storage apparatus 102. The storage locations of the data blocks are managed using slot numbers. For example, the storage locations of the data blocks B#1, B#2, B#3, . . . are mapped to slot numbers 1, 2, 3, . . .

The block map 221 is information that indicates a mapping between each logical address indicating the storage location of a data block and a slot number corresponding to the data block, as illustrated in a part A of FIG. 6. For example, the logical address indicates a location within a logical storage space, such as a logical volume, a virtual disk, or a logical unit number (LUN). When a data block is deduplicated, a plurality of logical addresses are mapped to the same slot number.

The block map 211 stored in the control information area 201 is part of the block map 221, and includes logical addresses x1, . . . , and x6, for example.

The container meta-information 222 indicates a mapping between each slot number and a physical address indicating the storage location of a data block corresponding to the slot number, as illustrated in FIG. 7. The container meta-information 212 may additionally include a compression size of the data block. The physical address indicates a location within a physical storage space provided by the UDC 202 or storage device 123.

It is possible to specify a mapping between a logical address and a physical address with respect to each data block on the basis of the block map 221 and container meta-information 222. Referring to the example of FIG. 7, the block map 221 indicates that the logical addresses x2 and x6 are mapped to the same slot number 2. In addition, the container meta-information 222 indicates that the slot number 2 is mapped to the physical address y2. This means that the same data block is stored in the logical addresses x2 and x6, and when an access is made to either one of the logical addresses x2 and x6, the physical address y2 is referenced.

The container meta-information 212 stored in the control information area 201 is part of the container meta-information 222 and includes the slot numbers corresponding to the logical addresses registered in the block map 211 stored in the control information area 201, for example.

The reference counter 223 is information that indicates the correspondence between each slot number and its count value (reference count), as illustrated in FIG. 7. A reference count indicates the number of logical addresses mapped to a slot number. That is to say, the reference count indicates how many logical addresses are mapped to the same physical address as a result of deduplication, more specifically, how many logical addresses reference the physical address.

The reference counter 213 stored in the control information area 201 is part of the reference counter 223 and includes the slot numbers registered in the container meta-information 212 stored in the control information area 201, for example.

The hash information 214 indicates the correspondence between a hash value and a slot number with respect to each data block, as illustrated in a part B of FIG. 6. For example, the hash information 214 indicates that the hash values H#1, H#2, H#3, correspond to the slot numbers 1, 2, 3, . . . , respectively. The contents and hash value of a data block have a one-to-one correspondence, and this means that the hash information 214 indicates the correspondence between the slot number and the contents of the data block.

As described above, the block map 211, container meta-information 212, and reference counter 213 are cache data corresponding to parts of the block map 221, container meta-information 222, and reference counter 223 stored in the storage device 123, respectively.

When a write request (new write request or rewrite request) for user data is made, the mapping between a logical address to which to write the user data and a slot number may be updated. This update is reflected on the control information including the block map 211 stored in the control information area 201, and in addition, is reflected on the control information including the block map 221 stored in the storage device 123 at prescribed timing. That is to say, in response to the write request, the control information in the control information area 201 is updated, and after that, the control information in the storage device 123 is synchronized with the control information in the control information area 201 at prescribed timing.

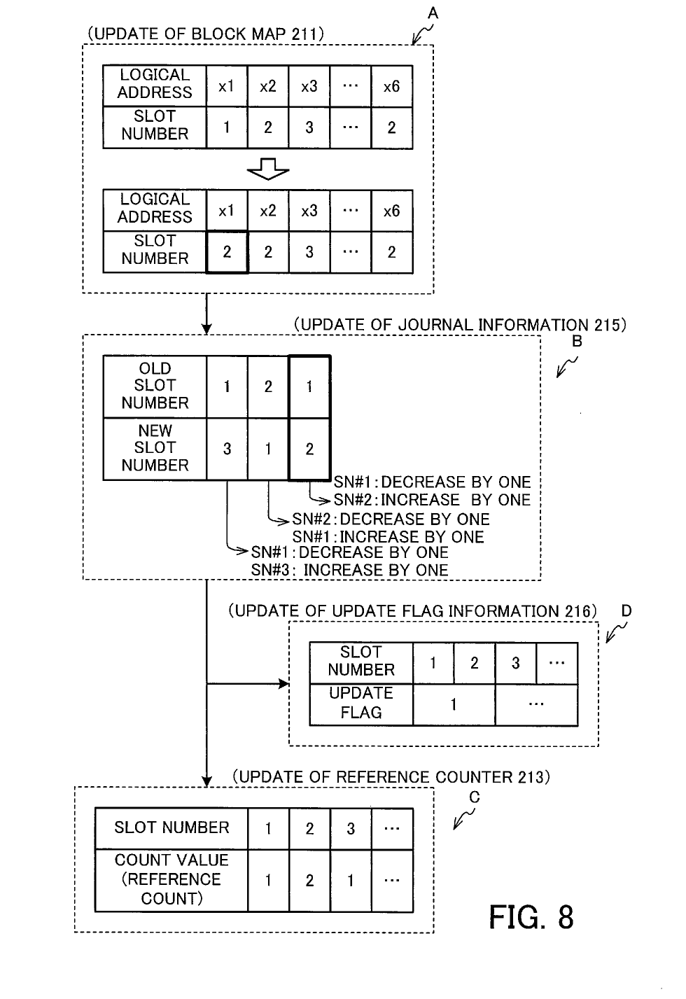

For example, in the case where a data block is written to the logical address x1, the block map 211 is updated as illustrated in a part A of FIG. 8. The part A of FIG. 8 illustrates an example where the data block to be written to the logical address x1 is the same as the data block stored at a physical address corresponding to the slot number 2 (that is, the deduplication is to be performed). In this case, the processor 121a updates the block map 211 so as to map the logical address x1 to the slot number 2.

The above update involves decreasing by one the number of logical addresses mapped to the slot number 1 and increasing by one the number of logical addresses mapped to the slot number 2. That is to say, the reference count of each of the slot numbers 1 and 2 is changed. When the reference count is changed, the processor 121a does not change the reference counter 213 immediately but records the change of the reference count in the journal information 215.

For example, the processor 121a sets, as an OLD slot number, the slot number corresponding to the logical address x1 before the update of the block map 211, and the slot number newly corresponding to the logical address x1 as a NEW slot number, as illustrated in a part B of FIG. 8. That is, the OLD slot number indicates a slot number before the rewriting, and the NEW slot number indicates a slot number after the rewriting. In this connection, in the case of a new write (i.e., if no slot number has been associated with the logical address), only the NEW slot number is set.

As illustrated in the part B of FIG. 8, the OLD slot number is a slot number for which the reference count is decreased by one. The NEW slot number is a slot number for which the reference count is increased by one. By recording the OLD slot number and the NEW slot number in the journal information 215 in this way, it becomes possible to detect changes in the reference count for each slot number.

The processor 121a reflects the updated contents of the journal information 215 on the reference counter 213 at prescribed timing, as illustrated in a part C of FIG. 8. In the case of the journal information 215 illustrated in the part B of FIG. 8, the reference count of the slot number 1 (SN#1) is decreased by one (increase by one and decrease by two), the reference count of the slot number 2 (SN#2) is not changed (increase by one and decrease by one), and the reference count of the slot number 3 (SN#3) is increased by one (increase by one). The processor 121a calculates the increase or decrease in the reference count with respect to each slot number on the basis of the journal information 215, and updates the count value (reference count) indicated in the reference counter 213 on the basis of the calculated increase or decrease.

The processor 121a manages the slot numbers corresponding to updated reference counts, using the update flag information 216 as illustrated in a part D of FIG. 8. In this connection, the processor 121a may group one or a plurality of slot numbers and manages whether there is any change (update) in the reference counts for each group. The part D of FIG. 8 illustrates an example where two slot numbers are grouped and it is managed whether an update has been made. In this connection, an update flag is used to indicate whether an update has been made. In this example, an update flag of one indicates that an update has been made, whereas an update flag of zero indicates that no update has been made.

The update flag information 216 illustrated in the part D of FIG. 8 indicates that the reference count of the slot number 1 or 2 has been updated. The update flag is reset when the reference counter 223 in the storage device 123 is synchronized with the reference counter 213 in the control information area 201. In this connection, the reference counter 223 is synchronized with the reference counter 213, independently of the timing of writing user data. After the reference counter 223 is synchronized with reference counter 213, the processor 121a updates (resets) the update flags of the corresponding slot numbers to zero.

(GC Process)

The count values of the reference counter 223 are used in GC, for example. The GC is a process of removing a data block that is no more referenced by any logical address. The processor 121a that performs the GC detects a slot number corresponding to a count value of zero, with reference to the count values of the reference counter 223. Then, the processor 121a specifies a physical address corresponding to the detected slot number with reference to the container meta-information 222. After that, the processor 121a removes the data block stored at the specified physical address.

As described above, the reference counter 223 stored in the storage device 123 is used in the GC. Therefore, if the updated contents of the reference counter 213 are not reflected on the reference counter 223 stored in the storage device 123 due to a failure of the CM 121 or another problem, the following risk arises: a data block corresponding to a slot number whose count value is actually not zero might be removed. To deal with this, when performing the GC, the processor 121a excludes, from the GC, slot numbers with the update flags of one among slot numbers with the count values of zero in the reference counter 223, with reference to the update flag information 216.

In addition, when updating the update flag information 216, the processor 121a notifies the CM 122 of the updated update flag information 216. The GC may be performed by the CM 122. In this case, the CM 122 specifies slot numbers to be subjected to the GC on the basis of the count values of the reference counter 223 stored in the storage device 123 and the update flags indicated in the update flag information 216, as with the above-described processor 121a. Then, the CM 122 performs the GC on the slot numbers specified for the GC.

In this connection, as with the CM 121 (processor 121a), the CM 122 manages a block map, container meta-information, reference counter, hash information, journal information, and update flag information. When updating the update flag information, the CM 122 notifies the CM 121 of the updated update flag information. When performing the GC, the processor 121a specifies slot numbers to be subjected to the GC, with reference to the update flag information received from the CM 122 in addition to the update flag information 216 stored in the control information area 201.

In the way described above, part of the reference counter 223 is cached as the reference counter 213 in the memory 121b (control information area 201) and the reference counter 213 is updated at the write time. By doing so, it is possible to reduce the frequency of access to the storage device 123. In the case where the storage device 123 has a limited number of rewrites, like an SSD, the reduction in the access frequency contributes to prolonging the lifetime of the storage device 123. In addition, the reduction in the frequency of access to the storage device 123 also contributes to reducing the processing load of the storage device 123.

In addition, even if the reference counter 223 is not synchronized with the reference counter 213 due to a failure of the CM 121 or another problem, the use of the update flag information 216 makes it possible to exclude data blocks corresponding to slot numbers whose count values have not been synchronized, from the GC, so as to avoid the risk of removing data blocks that are actually referenced by logical addresses. In addition, the sharing of the update flag information between the CMs 121 and 122 also makes it possible to avoid the above risk when either CM performs the GC.

Heretofore, the storage system 100 has been described.

(2-2. Processing Flow)

The following describes how the storage apparatus 102 operates.

(Write Process)

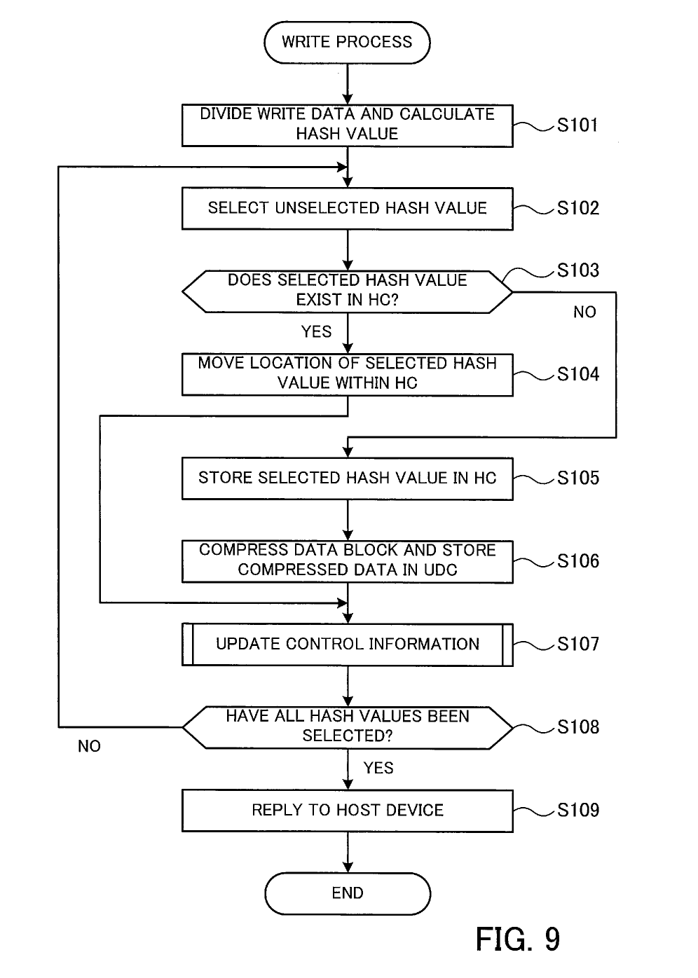

A write process will be described with reference to FIG. 9. FIG. 9 is a flow diagram for explaining how to write user data.

(S101) When receiving a write request for write data from the host device 101, the processor 121a divides the write data into a plurality of data blocks. In addition, the processor 121a calculates the hash value of each data block.

(S102) The processor 121a selects one unselected hash value from the plurality of hash values calculated at S101. The hash value selected at S102 is referred to as a selected hash value.

(S103) The processor 121a determines whether the selected hash value exists in the HC 203. If the selected hash value is found in the HC 203, the process proceeds to S104; otherwise, the process proceeds to S105.

(S104) The processor 121a moves the location of the selected hash value to a location where the selected hash value is taken as the newest one within the HC 203 (refer to FIG. 4). After S104 is completed, the process proceeds to S107.

(S105) The processor 121a stores the selected hash value in the HC 203. If the HC 203 is full, the processor 121a removes the oldest hash value from the HC 203 to create a free space. Then, the processor 121a stores the selected hash value in the HC 203 (refer to FIG. 3).

(S106) The processor 121a compresses the data block corresponding to the selected hash value. Then, the processor 121a generates compressed data by appending the selected hash value to the compressed data block and stores the compressed data in the UDC 202.

(S107) The processor 121a updates the control information.

(Update substep #1) In the case where the selected hash value is found in the HC 203 (Yes at S103), the processor 121a specifies a slot number corresponding to the selected hash value (i.e., the slot number corresponding to the existing data block) with reference to the hash information 214. Then, the processor 121a registers the logical address of the data block corresponding to the selected hash value in the block map 211 and also registers the specified slot number in association with the registered logical address.

If another slot number (OLD slot number) has been associated with the registered logical address in the block map 211, the processor 121a registers the OLD slot number in the journal information 215. In addition, the processor 121a registers the above-specified slot number (NEW slot number) in association with the registered OLD slot number in the journal information 215.

(Update substep #2) In the case where the selected hash value is not found in the HC 203 (No at S103), the processor 121a registers, in the block map 211, a logical address to which to write the data block corresponding to the selected hash value, and also registers a newly assigned slot number in association with the registered logical address. Then, the processor 121a registers the new slot number in the hash information 214 and also registers the selected hash value in association with the registered slot number.

Then, the processor 121a registers the new slot number in the container meta-information 212 and also registers a physical address (in this case, an address indicating a location in the UDC 202) at which to store the data block corresponding to the selected hash value, in association with the registered slot number. The processor 121a then registers the compression size of the data block in association with the registered slot number. In addition, the processor 121a registers the new slot number (NEW slot number) in the journal information 215.

(S108) The processor 121a determines whether all hash values have been selected. If there is any hash value unselected, the process proceeds to S102; otherwise, the process proceeds to S109.

(S109) The processor 121a sends the host device 101 a notification indicating a write completion of the write data as a response to the write request. After S109 is completed, the process of FIG. 9 is completed.

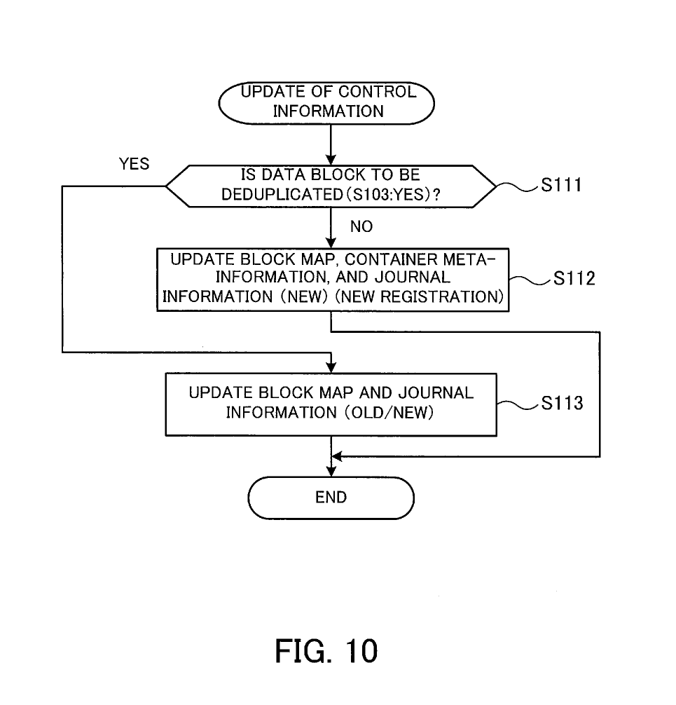

Now, a processing flow of updating the control information (a process of S107) will be described with reference to FIG. 10. FIG. 10 is a flow diagram for explaining how to update the control information.

(S111) The processor 121a determines whether to deduplicate the data block corresponding to the selected hash value (i.e., whether the selected hash value is found in the HC 203 at S103). If the data block is to be deduplicated, the process proceeds to S113; otherwise, the process proceeds to S112.

(S112) The processor 121a registers a logical address to which to write the data block corresponding to the selected hash value, in the block map 211, and also registers a newly assigned slot number in association with the registered logical address. In addition, the processor 121a registers the new slot number in the hash information 214 and also registers the selected hash value in association with the registered slot number.

Then, the processor 121a registers the new slot number in the container meta-information 212 and also registers a physical address at which to store the data block corresponding to the selected hash value, in association with the registered slot number. In addition, the processor 121a registers the compression size of the data bock in association with the registered slot number in the container meta-information 212. Then, the processor 121a registers the new slot number (NEW slot number) in the journal information 215. After S112 is completed, the process of FIG. 10 is completed.

(S113) The processor 121a specifies the slot number corresponding to the selected hash value (i.e. the slot number corresponding to the existing data block) with reference to the hash information 214. Then, the processor 121a registers the logical address of the data block corresponding to the selected hash value in the block map 211 and also registers the specified slot number in association with the registered logical address.

If another slot number (OLD slot number) has been associated with the registered logical address in the block map 211, the processor 121a registers the OLD slot number in the journal information 215 and also registers the above-specified slot number (NEW slot number) in association with the registered OLD slot number in the journal information 215.

If no slot number (OLD slot number) has been associated with the registered logical address in the block map 211, the processor 121a registers the NEW slot number in the journal information 215. After the block map 211 and journal information 215 are updated, the process of FIG. 10 is completed.

(Update of Reference Counter)

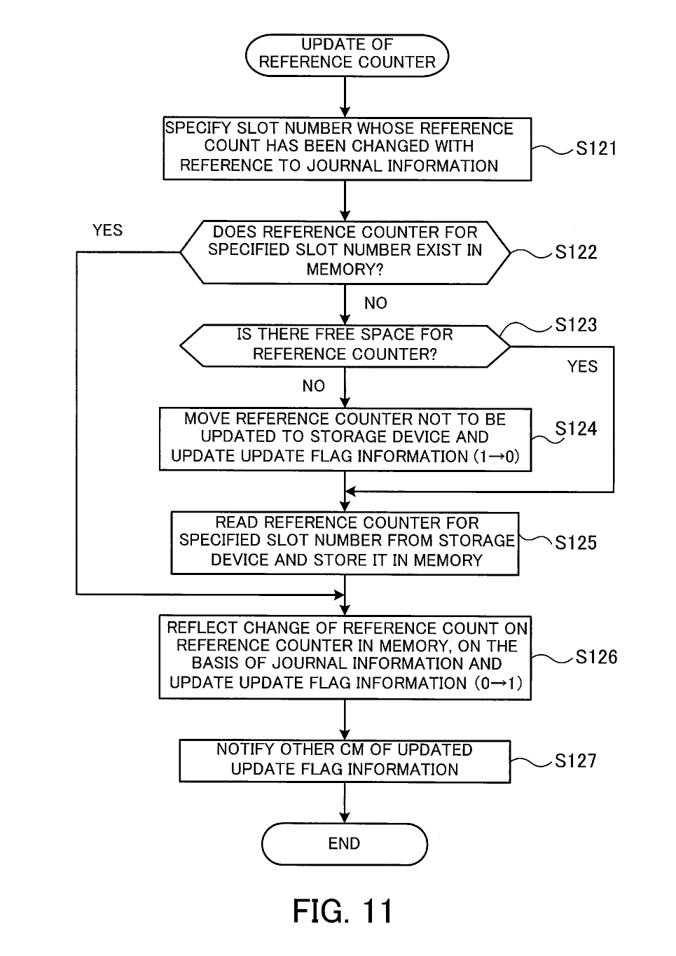

A processing flow of updating the reference counter will be described with reference to FIG. 11. FIG. is a flow diagram for explaining how to update the reference counter. In this connection, the reference counter 213 is updated, for example, when the number of records in the journal information 215 reaches a prescribed value, when a prescribed time has elapsed from the last update, or at preset time intervals (every hour) or timing.

(S121) The processor 121a specifies a slot number whose reference count has been changed, with reference to the journal information 215. For example, FIG. 8 illustrates an example where the reference count of the slot number 1 (SN#1) is decreased by one (increase by one and decrease by two), and the reference count of the slot number 3 is increased by one. In this case, the processor 121a specifies the slot numbers 1 and 3 with reference to the journal information 215.

(S122) The processor 121a determines whether the contents (count value) of the reference counter 213 corresponding to the slot number specified at S121 exist in the memory 121b (control information area 201). If the contents of the reference counter 213 corresponding to the slot number specified at S121 are found in the memory 121b, the process proceeds to S126; otherwise, the process proceeds to S123.

(S123) The processor 121a determines whether the control information area 201 has a free space for storing the contents of the reference counter 213 corresponding to the slot number specified at S121 (a free space for reference counter). If the control information area 201 has a free space for the reference counter, the process proceeds to S125; otherwise, the process proceeds to S124.

(S124) The processor 121a moves the contents (i.e., count values not to be updated) of the reference counter 213 corresponding to slot numbers other than the slot number specified at S121 to the storage device 123 to create a free space. In addition, the processor 121a updates the update flags of the slot numbers corresponding to the count values not to be updated, to zero in the update flag information 216.

(S125) The processor 121a reads the contents of the reference counter 223 corresponding to the slot number specified at S121 from the storage device 123. Then, the processor 121a stores the read contents of the reference counter 223 in the memory 121b (control information area 201). In this connection, the contents of the reference counter 223 stored in the control information area 201 are used as the reference counter 213.

(S126) The processor 121a reflects the change of the reference count on the reference counter 213 in the memory 121b (control information area 201), on the basis of the journal information 215.

For example, in the case of the journal information 215 illustrated in FIG. 8, the reference count of the slot number 1 is decreased by one and the reference count of the slot number 3 is increased by one. In this case, the processor 121a decreases the count value of the slot number 1 by one and increases the count value of the slot number 3 by one in the reference counter 213.

In addition, the processor 121a updates the update flag corresponding to the slot number in question (in this example, slot numbers 1 and 3) to one in the update flag information 216.

(S127) The processor 121a notifies the other CM (CM 122) of the updated update flag information 216. After S127 is completed, the process of FIG. 11 is completed. In this connection, the CMs 121 and 122 manage different slot numbers, but the CM 122 operates in the same way as the CM 121. When receiving the update flag information from the CM 122, the processor 121a stores the received update flag information in the memory 121b.

(GC Process)

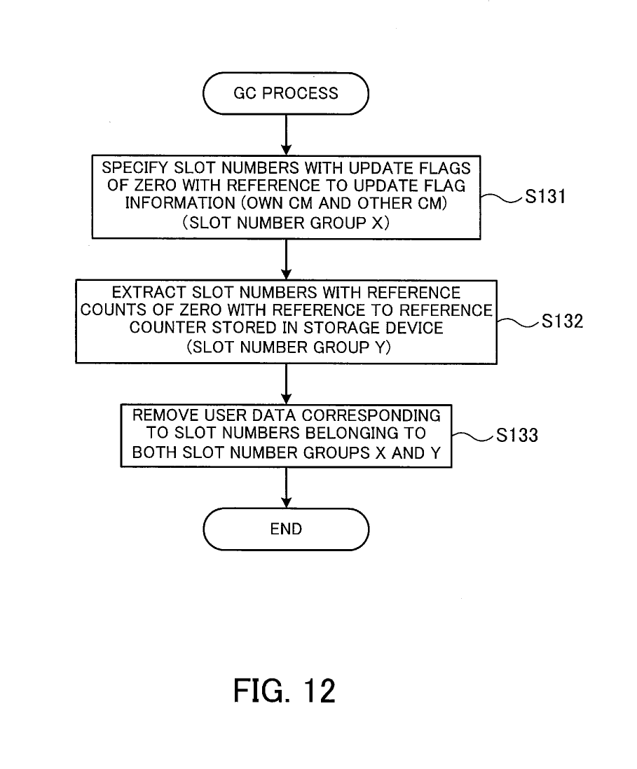

The GC process will now be described with reference to FIG. 12. FIG. 12 is a flow diagram for explaining how to perform the GC process.

(S131) The processor 121a specifies slot numbers with the update flags of zero with reference to the update flag information 216. In addition, when the processor 121a has received update flag information from the CM 122 (another CM), the processor 121a specifies slot numbers with the update flags of zero with reference to the update flag information of the CM 122. In this connection, a set of slot numbers specified at S131 is collectively referred to as a slot number group X for simple explanation.

(S132) The processor 121a extracts slot numbers with the count values (reference counts) of zero with reference to the reference counter 223 stored in the storage device 123. In this connection, a set of slot numbers extracted at S132 is collectively referred to as a slot number group Y for simple explanation.

(S133) The processor 121a removes user data corresponding to slot numbers belonging to both the slot number groups X and Y from the UDC 202 and storage device 123. After S133 is completed, the process of FIG. 12 is completed.

(Read Process)

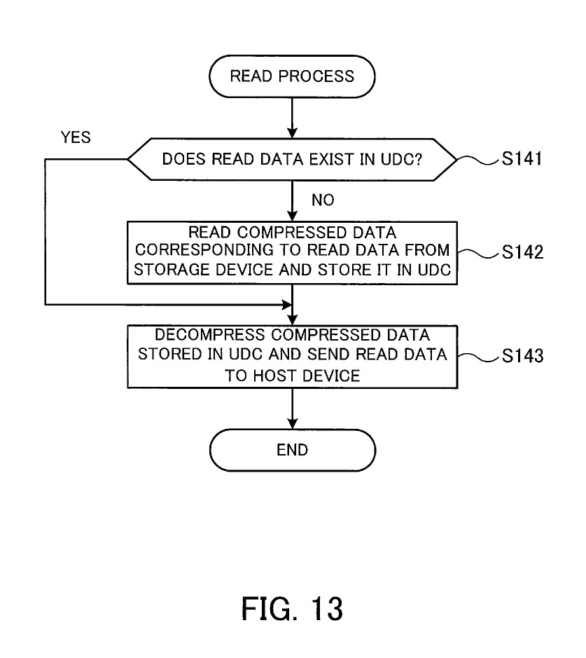

A read process will now be described with reference to FIG. 13. FIG. 13 is a flow diagram for explaining how to read user data.

(S141) When receiving a read request for read data from the host device 101, the processor 121a determines whether the read data exists in the UDC 202.

For example, the processor 121a determines whether a physical address corresponding to the logical address of the requested read data is an address of the UDC 202 or the storage device 123, with reference to the block map 211 and container meta-information 212.

If the logical address of the requested read data corresponds to a physical address of the UDC 202, the processor 121a determines that the read data is stored in the UDC 202. If the logical address of the requested read data corresponds to a physical address of the storage device 123, the processor 121a determines that the read data is stored in the storage device 123.

If the read data is determined to be stored in the UDC 202, the process proceeds to S143. If the read data is determined not to be stored in the UDC 202 (i.e., if the read data is determined to be stored in the storage device 123), the process proceeds to S142.

(S142) The processor 121a reads the read data from the storage device 123 and stores it in the UDC 202. For example, the processor 121a specifies the physical address corresponding to the logical address of the requested read data with reference to the block map 211 and container meta-information 212. Then, the processor 121a reads the compressed data from the specified physical address and stores it in the UDC 202.

(S143) The processor 121a decompresses the compressed data block included in the compressed data stored in the UDC 202 to thereby restore the original data block. In addition, the processor 121a restores the read data by combining a plurality of restored data blocks. Then, the processor 121a sends the restored read data to the host device 101 as a response to the read request.

After S143 is completed, the process of FIG. 13 is completed.

Heretofore, the processes performed by the storage apparatus 102 have been described.

As described above, part of the reference counter 223 is cached as the reference counter 213 in the memory 121b (control information area 201) and the reference counter 213 is updated at the write time. By doing so, it is possible to reduce the frequency of access to the storage device 123 by caching. In the case where the storage device 123 has a limited number of rewrites, like an SSD, the reduction in the access frequency contributes to prolonging the lifetime of the storage device 123. In addition, the reduction in the frequency of access to the storage device 123 contributes to reducing the processing load of the storage device 123.

Even if the reference counter 223 is not synchronized with the reference counter 213 due to a failure of the CM 121 or another problem, the use of the update flag information 216 makes it possible to exclude, from the GC, data blocks corresponding to slot numbers whose count values have not been synchronized, so as to avoid the risk of removing data blocks that are actually referenced by logical addresses. In addition, the sharing of the update flag information between the CMs 121 and 122 also makes it possible to avoid the above risk when either CM performs the GC.

The second embodiment has been described.

As described above, part of the reference counter 223 stored in the storage device 123 is stored as the reference counter 213 in the memory 121b, and the reference counter 213 is updated. By doing so, it is possible to reduce the load of rewriting to the storage device 123. In addition, the status of synchronization between the reference counters 213 and 223 is managed using the update flag information 216. By doing so, it is possible to avoid a risk of removing user data with a reference count other than zero in the GC, which is performed based on the reference counter 223.

Note that the functions of the above-described CM 121 may be implemented by the processor 121a running a program.

The program may be recorded on a computer-readable recording medium. Computer-readable recording media include magnetic storage devices, optical discs, magneto-optical recording media, and semiconductor memories. The magnetic storage devices include hard disk drives (HDDs), flexible disks (FDs), magnetic tapes (MTs), and others. The optical discs include Digital Versatile Discs (DVDs), DVD-RAMs, compact disc-read only memories (CD-ROMs), CD-Rs (recordable), CD-RWs (rewritable), and others. Magneto optical recording media include magneto-optical disks (MOs) and others.

To distribute the program, portable recording media, such as DVDs and CD-ROMs, on which the program is recorded, may be put on sale, for example. Alternatively, the program may be stored in a memory device of a server computer and may be transferred from the server computer to other computers through the network.

A computer that runs the program stores in its local storage device the program recorded on a portable recording medium or transferred from the server computer, for example. Then, the computer reads and runs the program from the storage device.

The computer may read and run the program directly from the portable recording medium. Also, while receiving the program being transferred from the server computer through the network, the computer may sequentially run this program.

According to one aspect, it is possible to avoid a risk of losing data blocks.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A storage control apparatus comprising:
a memory configured to store information about a reference count indicating a number of logical addresses that reference a data block and information indicating an update status of the reference count; and
a processor configured to perform a first process including
updating, when the reference count is changed, the information about the reference count stored in the memory and setting the update status such as to indicate that the reference count has been updated,
storing, at prescribed timing, the information about the reference count that has been updated in a storage device and setting the update status such as to indicate that the reference count has not been updated, and
excluding, when performing a second process based on the reference count, the data block corresponding to the reference count that has been updated, from the second process.

2. The storage control apparatus according to claim 1, wherein the second process is to remove the data block corresponding to the reference count with a value of zero.

3. The storage control apparatus according to claim 1, wherein the first process further includes notifying another storage control apparatus of the update status, so as to exclude the data block corresponding to the reference count that has been updated, from the second process performed by the another storage control apparatus, the another storage control apparatus being able to perform the second process.

4. A non-transitory computer-readable recording medium storing a computer program that causes a computer to perform a first process including:
storing, in a memory, information about a reference count indicating a number of logical addresses that reference a data block and information indicating an update status of the reference count;
updating, when the reference count is changed, the information about the reference count stored in the memory and setting the update status such as to indicate that the reference count has been updated,
storing, at prescribed timing, the information about the reference count that has been updated in a storage device and setting the update status such as to indicate that the reference count has not been updated; and
excluding, when performing a second process based on the reference count, the data block corresponding to the reference count that has been updated, from the second process.

5. The non-transitory computer-readable recording medium according to claim 4, wherein the second process is to remove the data block corresponding to the reference count with a value of zero.

6. The non-transitory computer-readable recording medium according to claim 5, wherein the first process further includes notifying another computer of the update status, so as to exclude the data block corresponding to the reference count that has been updated, from the second process performed by the another computer, the another computer being able to perform the second process.
